(19) United States
(12) Patent Application Publication
(10) Pub. No.: US 2020/0156952 A1
(43) Pub. Date: May 21, 2020

(54) A PLANT, SUCH AS AMMONIA PLANT, COMPRISING AN ABSORPTION REFRIGERATION UNIT

(71) Applicant: CASALE SA, Lugano (CH)

(72) Inventors: Marco Carlucci Mazzamuto, Rovellasca (IT); Sergio Panza, Como (IT); Simone Gamba, Pagazzano (IT)

(21) Appl. No.: 16/621,360

(22) PCT Filed: Jun. 5, 2018
(86) PCT No.: PCT/EP2018/064678

§ 371 Date: Dec. 11, 2019

(30) Foreign Application Priority Data
Jun. 16, 2017 (EP) 17176411.1

(51) Int. Cl. C01C 1/04; C01B 3/02; F25B 15/06; F25B 29/00

(52) U.S. Cl. CPC C01C 1/0452; C01C 1/0488; C01C 1/0417; C01B 3/025; C01B 2203/068; F25B 29/006; C01B 2203/0205; C01B 2203/061; F25B 15/06

(57) ABSTRACT

A chemical plant comprising a refrigeration system including an absorption refrigeration unit, and a steam system including one or more steam producers, steam users, and at least one steam condenser, wherein a heat exchanger is arranged to intercept at least part of a steam flow directed to said steam condenser, and said heat exchanger transfers heat to a working fluid of said absorption refrigeration unit to provide at least part of a heat input required for operation of said refrigeration system.

### FIELD OF APPLICATION

The invention concerns a chemical plant comprising a steam system and a refrigeration system including an absorption refrigeration unit, and related methods of revamping. The invention concerns in particular an ammonia or methanol plant.

### PRIOR ART

Many chemical plants, such as ammonia synthesis plants, comprise a steam system.

An ammonia synthesis plant is understood as a plant wherein a make-up synthesis gas containing hydrogen and nitrogen is produced in a front-end section, typically by reforming of a hydrocarbon, and catalytically converted into ammonia product gas.

The steam system typically comprises one or more steam producers, steam users and at least one steam condenser. The steam producers may include heat exchangers which produce steam by cooling a hot process stream, such as the hot effluent of a catalytic converter. The steam users typically include steam turbines which may produce energy or drive auxiliary equipment such as pumps or compressors. Some steam can also be used internally in the process or exported.

The condenser of the steam system normally receives exhaust steam at a low pressure and temperature, typically at a pressure of less than 1 bar absolute and temperature of less than 100° C. Accordingly, said condenser is also referred to as steam exhaust condenser.

Said steam exhaust condenser is cooled by means of cooling water or air. The heat liberated by condensation of the exhaust steam is removed by said medium and then discharged to the environment, which is disadvantageous from an efficiency point of view because a considerable amount of energy is lost.

Absorption refrigeration units can be used to refrigerate process streams when appropriate, for example absorption refrigeration units are used in the ammonia plants for refrigeration of the make-up synthesis gas or of the ammonia product gas.

Referring more in detail to a plant for the synthesis of ammonia, the front-end section generally includes a reforming section wherein the hydrocarbon feedstock is converted into a raw synthesis gas, and a purification section which typically comprises one or more shift converters, a carbon dioxide removal section and optionally a methanation section.

The purified synthesis gas from said purification section is obtained at a pressure which is much lower than the synthesis pressure (e.g. 15 to 30 bar); hence it is compressed to the synthesis pressure of around 80-300 bar in a multi-stage compressor driven by a turbine of the steam system.

Compressors for process air sent to the reforming section, ammonia, carbon dioxide or natural gas may also be driven by steam turbines of the steam system.

The condenser of the steam system of an ammonia plant normally receives exhaust steam at a pressure of 0.2 to 0.7 bar and temperature of 60 to 90° C.

### SUMMARY OF THE INVENTION

The invention aims to improve the efficiency of the above referred chemical plant from the energetic point of view.

The idea underlying the invention is to use the heat of the steam sent to the exhaust condenser as a heat input for an absorption machine, which may be advantageously used in a chemical plant (e.g. an ammonia plant) to improve its efficiency. Despite its low temperature, the steam fed to the exhaust condenser is still useful to provide a heat input for said absorption machine.

Accordingly, the heat content of the steam is efficiently recovered within the process, instead of being entirely discharged to ambient.

This aim is reached with a chemical plant according to claim 1.

Said chemical plant comprises a refrigeration system and a steam system, wherein the refrigeration system includes at least an absorption refrigeration unit and the steam system comprises one or more steam producers, steam users, and at least one steam condenser, the plant being characterized in that:

a heat exchanger is arranged to intercept at least part of a steam flow directed to said steam condenser, and

said heat exchanger transfers heat to a working fluid of said absorption refrigeration unit, to provide at least part of a heat input required for operation of said refrigeration system.

Said condenser preferably receives an exhaust steam discharged for example from a steam turbine. Accordingly, in the description below, said steam condenser will be also referred to as a steam exhaust condenser.

Said condenser is not part of the absorption refrigeration unit. Accordingly, a feature of the invention is that the heat content of at least part of a steam flow, which is originally directed to condensation, is transferred to said absorption refrigeration unit. Heat originally released to a cooling medium of the condenser is used internally, in a more efficient manner, to drive the refrigeration unit. For example said heat is transferred to a working fluid of the absorption refrigeration unit. In a preferred embodiment, heat is transferred to said working fluid at a mean temperature which is higher than the temperature of condensation of said condenser.

Preferably, the aforementioned heat exchanger is fitted within a steam duct directed to said steam exhaust condenser. Said heat exchanger provides for a heat exchange between the steam and the working fluid of the absorption refrigeration unit. Said heat exchanger preferably comprises a coil or a tube bundle, which is exposed to the steam and which is internally traversed by said working fluid.

Preferably, the steam entering the heat exchanger has a temperature ranging from 60 to 90° C., more preferably ranging from 75 to 85° C.

Said working fluid is preferably a binary solution consisting of a refrigerant and an absorbent. Said binary solution preferably comprises lithium bromide (LiBr) and water, the LiBr acting as absorbent and the water acting as refrigerant. The refrigerant may be an absorbed fluid.

According to an embodiment of the invention, said absorption refrigeration unit provides a liquid refrigerant (e.g. water) to a chiller, wherein it is heated up, thus refrigerating a process stream.

The absorption refrigeration unit essentially comprises:

an absorber, wherein refrigerant vapours are absorbed by a rich solution of the absorbent (e.g. LiBr), thus producing an absorbent lean solution and releasing some heat;

a regenerator, wherein the refrigerant is evaporated from said lean solution and the above mentioned rich solution is separated for further use in the absorber;

a condenser, wherein the refrigerant vapours extracted from said lean solution are condensed by means of a cooling medium (e.g. cooling water);

an evaporator, wherein the condensed refrigerant is evaporated at lower pressure, thus cooling down the above mentioned liquid refrigerant which is then available e.g. for the refrigerating process in the chiller.

According to a further embodiment of the invention, said absorption refrigeration unit directly cools a process stream without providing the liquid refrigerant to a chiller.

Low-temperature heat is discharged by said absorber and said condenser, which is generally transferred to a stream of cooling water by indirect heat exchange.

The driving force of the process is the heat furnished to the regenerator for separating the refrigerant vapours from the lean solution to provide an absorbent-rich solution.

According to an embodiment, the steam directed to said steam exhaust condenser is used to heat, in a proper heater, the lean solution provided by the absorber before its admission into the regenerator. According to another embodiment, the steam directed to said steam exhaust condenser may be used to boil said lean solution inside the regenerator itself.

As a consequence, an external heat input to the regenerator may be avoided or advantageously reduced. This represents a significant advantage of the present invention.

According to various embodiments of the invention, said refrigeration system may also comprise a further absorption refrigeration unit and/or a compression refrigerator, besides the aforementioned absorption refrigeration unit.

According to a preferred embodiment, the chemical plant according to invention is an ammonia plant.

An ammonia plant also comprises a front-end section for the generation of a make-up synthesis gas and a synthesis section for the conversion of said make-up synthesis gas into an ammonia-containing product. The generation of said make-up synthesis gas preferably takes place by reforming of a hydrocarbon feedstock, which may involve a primary reforming with steam and a secondary reforming in the presence of a flow of a suitable oxidant, for example air.

The absorption refrigeration unit of an ammonia plant may be used for the refrigeration of said air flow, of said make-up synthesis gas and of said ammonia-containing product.

According to another preferred embodiment, said chemical plant is a plant for the synthesis of methanol.

Other objects of the present invention are methods of revamping according to the annexed claims.

According to an embodiment of the invention, the installation of the heat exchanger comprises removing a part of the original steam duct directed to the steam exhaust condenser, said part being adjacent to the steam exhaust condenser, and installing the heat exchanger between the remaining part of the steam duct and the steam exhaust condenser. Said original steam duct is for example a discharge tube of a steam turbine.

According to another embodiment, the installation of the heat exchanger comprises replacing the original duct with a new steam duct of smaller length and installing the heat exchanger between the newly installed duct and the steam exhaust condenser.

The newly installed heat exchanger preferably comprises a coil or a tube bundle, which is exposed to the steam and which is internally traversed by said working fluid. Said heat exchanger advantageously comprises an inlet and an outlet for said working fluid circulating inside said coil or tube bundle.

The main advantage of the present invention is that the steam directed to the steam exhaust condenser(s) of the steam system is used as a heat source to regenerate the working fluid of an absorption refrigeration unit. Accordingly, the heat content of the steam is efficiently recovered within the process.

The liquid refrigerant chilled by the absorption refrigeration unit can be employed within the plant. For example, in an ammonia plant, said liquid refrigerant can be used as cooling means for the synthesis gas or the process air, thus improving the energy efficiency of the plant itself.

Still thanks to the lower heat content of the steam fed to the steam exhaust condenser, the cooling medium required for the condensation is less. This is particularly advantageous when cooling water is used as cooling medium, since the amount saved of cooling water can be used for other purposes, for example for removing the heat discharged by the absorber and the condenser of the absorption refrigeration unit.

Additionally, thanks to the lower heat content of the steam fed to the steam exhaust condenser, the operating pressure of said steam exhaust condenser can be lowered. This can improve the efficiency of the other steam users.

The advantages will emerge even more clearly with the aid of the detailed description below relating to a preferred embodiment.

### BRIEF DESCRIPTION OF THE DRAWINGS

FIG. 1 is a simplified block scheme of an ammonia plant according to a preferred embodiment of the invention.

FIG. 2 shows a simplified block scheme of the absorption refrigeration unit of the plant shown in FIG. 1, according to a preferred embodiment of the invention.

FIG. 3 shows a steam exhaust condenser of an ammonia plant according to the prior art.

FIG. 4 shows a steam exhaust condenser of an ammonia plant according to an embodiment of the invention.

### DETAILED DESCRIPTION

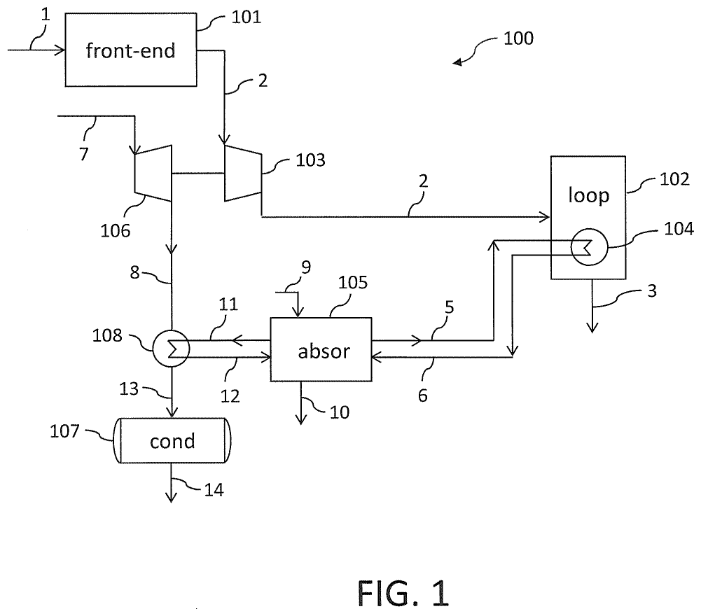

FIG. 1 illustrates a simplified scheme of an ammonia plant 100.

A hydrocarbon feedstock 1 is reformed in a front-end section 101 producing a make-up synthesis gas 2. Said synthesis gas 2 is obtained at a pressure of 15-30 bar or greater in the front-end section 101 and is fed to a synthesis loop 102 via a multi-stage syngas compressor 103. The synthesis loop 102 works at a synthesis pressure of about 80-300 bar.

The synthesis loop 102 produces an ammonia-containing product 3. Said synthesis loop 102 contains a chiller 104, which is supplied with a cold liquid refrigerant 5 provided by an absorption refrigeration unit 105 and contributes to the chilling of the ammonia-containing product 3. The resulting hot liquid refrigerant 6 then returns to said absorption refrigeration unit 105.

The ammonia plant 100 also comprises a steam system which typically includes steam generators and steam turbines. Steam generators include for example heat exchangers which remove heat from the front-end section 101, e.g. from hot reformed gas. Steam turbines include for example a turbine 106 coupled to said multi-stage syngas compressor 103 and supplied with steam 7. For the sake of simplicity, in the example of the figure only the steam turbine 106 is illustrated.

The steam system further comprises a steam exhaust condenser 107 which receives the steam discharged from the one or more steam turbines, e.g. steam 13.

The steam system can further provide steam 9 which furnishes a heat input to the absorption refrigeration unit 105 and said unit 105 can return steam 10 with a lower heat content.

At least part of the heat input to said absorption refrigeration unit 105 is furnished by steam 8 before its condensation in the steam exhaust condenser 107, through a heat exchanger 108.

More in detail, the absorption refrigeration unit 105 operates with a working fluid. Said working fluid requires heat to be regenerated, according to the known technique of the absorption machines. In the example of FIGS. 1 to 4, reference will be made to an aqueous solution of LiBr, wherein LiBr acts as absorbent and water acts as refrigerant.

In the example of FIG. 1, the working fluid 11 enters, preferably via a pump (not shown), the heat exchanger 108 wherein it is heated by the steam 8. The heated working fluid 12 so-obtained returns to the absorption refrigeration unit 105, and steam 13 leaving the heat exchanger 108 with low thermal content is sent to the steam exhaust condenser 107. Said steam exhaust condenser 107 provides a steam condensate 14.

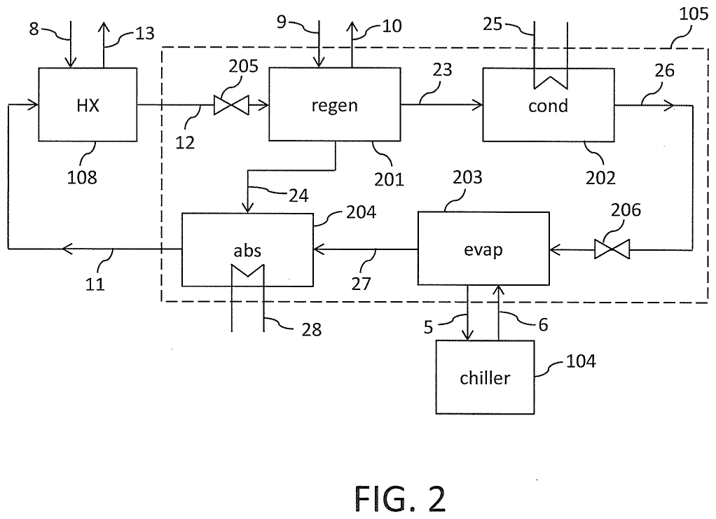

As shown in FIG. 2, said absorption refrigeration unit 105 essentially comprises a regenerator 201, a condenser 202, an evaporator 203 and an absorber 204.

After being pre-heated into said heat exchanger 108, said working fluid 12 is flashed through a valve 205, then enters the regenerator 201 wherein water vapours 23 are separated from a LiBr rich solution 24. Said rich solution 24 is recycled to the absorber 204.

According to the example of FIG. 2, steam 9 is furnished as additional heat input to the regenerator 201 to better regenerate the working fluid, and steam 10 with a lower heat content is exported from the absorption refrigeration unit 105.

The water vapours 23 extracted from said regenerator 201 are sent to the condenser 202, wherein they are condensed by a cooling medium 25 (e.g cooling water), providing a condensate 26. Said condensate 26 is supplied to the evaporator 203 through a valve 206. Said evaporator 203 is also supplied with the hot liquid refrigerant 6 obtained from the chiller 104, wherein it is regenerated. Accordingly, inside said evaporator 203, the condensate 26 is evaporated at lower pressure providing water vapours 27, and said liquid refrigerant 6 is cooled down thus being again available for the refrigerating process in the chiller 104.

Said water vapours 27 are supplied to the absorber 204, wherein they are absorbed by said LiBr rich solution 24 with the help of a cooling water 28. The absorber 204 provides a lean LiBr solution 11, which feeds the heat exchanger 108 wherein it is heated by steam 8, obtaining the stream 12.

According to another embodiment of the invention, said absorption refrigeration unit directly cools the ammonia-containing product 3 without providing the liquid refrigerant 5 to a chiller.

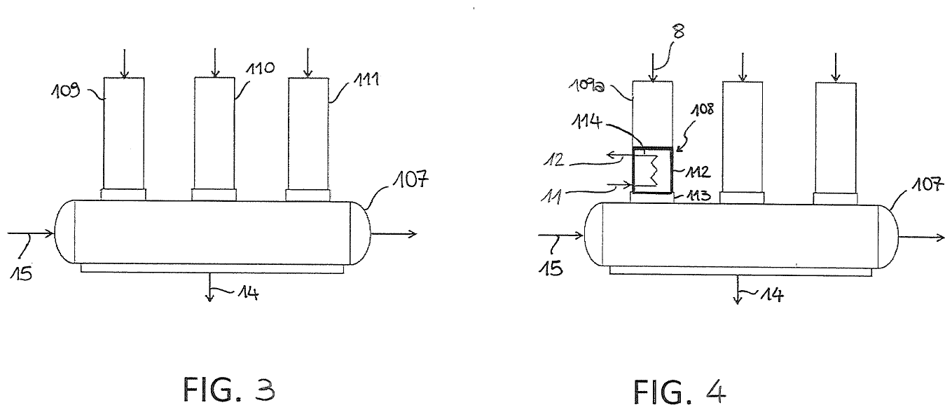

A preferred embodiment of said heat exchanger 108 is depicted in FIG. 4. This embodiment may advantageously result from the revamping of the system shown in FIG. 3.

According to FIG. 3, the condenser 107 receives steam from a plurality of conduits 109, 110, 111, e.g. the discharge tubes of steam turbines, and provides the steam condensate 14. The cooling medium 15 used in the condenser 107 is for example cooling water.

The method of revamping according to the embodiment shown in FIG. 4 comprises: replacing one or more of the conduits 109-111, e.g. the conduit 109, with a new discharge tube 109a of smaller length; installing the heat exchanger 108 between the tube 109a and a nozzle 113 of the condenser 107; installing a coil or a tube bundle 114 inside the shell 112 of said heat exchanger 108 for the circulation of the working fluid 11 coming from the absorption refrigeration unit 105.

According to another embodiment, the method of revamping may comprise the removal of a portion of conduit 109 and the subsequent installation of the heat exchanger 108 in place of said removed portion.

According to the invention, the heat content of the steam 8 extracted from the steam turbines of the ammonia plant is recovered and advantageously employed in the absorption refrigeration unit 105, instead of being discharged via condensation of the steam 8 into the steam exhaust condenser 107. Accordingly, it is the steam 13 discharged from the heat exchanger 108, which has smaller heat content than the steam 8, to be condensed inside the steam exhaust condenser 107, thus providing the steam condensate 14.

1-14. (canceled)

15. A chemical plant, comprising:
a refrigeration system including at least an absorption refrigeration unit;
a steam system including one or more steam producers, steam users, and at least one steam condenser; and
a heat exchanger is arranged to intercept at least part of a steam flow directed to said steam condenser; said heat exchanger transfers heat to a working fluid of said at least one absorption refrigeration unit to provide at least part of a heat input required for operation of said refrigeration system.

16. The chemical plant of claim 15, wherein said heat exchanger is fitted within a steam duct directed to said at least one steam condenser.

17. The chemical plant of claim 15, wherein said heat exchanger includes a coil or tube bundle exposed to the steam and internally traversed by said working fluid.

18. The chemical plant of claim 15, wherein steam at an inlet of said heat exchanger has a temperature in a range of 60 to 90° C,.

19. The chemical plant of claim 18, wherein the temperature is in a range of 75 to 85° C.

20. The chemical plant of claim 15, wherein said working fluid of the at least one absorption refrigeration unit includes a binary solution of a refrigerant and an absorbent.

21. The chemical plant of claim 20, wherein said binary solution includes lithium bromide and water.

22. The chemical plant of claim 15, which is suitable for synthesis of ammonia and further comprising:
a front-end section for generation of a make-up synthesis gas; and
a synthesis section for conversion of said make-up synthesis gas into an ammonia-containing product;
wherein the generation of said make-up synthesis taking place by reforming of a hydrocarbon feedstock, and said reforming taking place in a presence of process air.

23. The chemical plant of claim 22, wherein said at least one absorption refrigeration unit is used for refrigeration of said make-up synthesis gas, said ammonia-containing product, or said process air.

24. The chemical plant of claim 15, which is suitable for the synthesis of methanol.

25. A method for revamping a chemical plant, said chemical plant including a refrigeration system and a steam system, wherein said steam system includes one or more steam producers, steam users, and at least one steam condenser, the method comprising:
installing an absorption refrigeration unit to said refrigeration system; and
installing a heat exchanger arranged to intercept at least part of a steam flow directed to said at least one steam condenser;
wherein said heat exchanger transfers heat to a working fluid of said absorption refrigeration unit to provide at least part of a heat input required for operation of said refrigeration system.

26. The method of claim 25, wherein installing said heat exchanger includes:
removing a steam duct originally directed to the steam condenser and installing a new steam duct of smaller length; and
installing the heat exchanger between the newly installed steam duct and the condenser.

27. The method of claim 25, wherein installing said heat exchanger includes:
removing a portion of a steam duct directed to the steam condenser, said portion being in proximity of said steam condenser; and
installing the heat exchanger in the place of said removed portion.

28. The method of claim 25, wherein said heat exchanger includes an inlet and an outlet for said working fluid.
